(19) United States
(12) Patent Application Publication
(10) Pub. No.: US 2014/0074894 A1
(43) Pub. Date: Mar. 13, 2014

(54) FORMAT CONVERSION OF METADATA ASSOCIATED WITH DIGITAL CONTENT

(71) Applicant: Sang Bumm Han, Incheon (KR)

(72) Inventor: Sang Bumm Han, Incheon (KR)

(73) Assignee: CLO VIRTUAL FASHION INC., Seoul (KR)

(21) Appl. No.: 13/613,569

(22) Filed: Sep. 13, 2012

(51) Int. Cl. G06F 17/30

(52) U.S. Cl. 707/803; 707/E17.005

(57) ABSTRACT

Embodiments of the present invention provide an approach for format conversion of metadata associated with digital content. In a typical embodiment, a set of metadata associated with digital content may be received in a computer memory medium. A source format of the set of metadata will then be detected (e.g., by a processor, engine, or combination thereof). Based on the source format, a rule file containing a set of soft conversion rules for the set of metadata will be identified by the processor/engine. Thereafter, a selection of at least one soft conversion rule of the set of soft conversion rules may be received (e.g., from a user, or from an automatic selection made by the processor/engine). The set of metadata may then be mapped and converted to a destination format by the processor/engine using the at least one soft conversion rule.

### TECHNICAL FIELD

In general, embodiments of the present invention relate to metadata format conversion. Specifically, embodiments of the present invention relate to format conversion of metadata associated with digital content (e.g., cable television content, Internet Protocol television (IPTV, etc).

### BACKGROUND OF THE INVENTION

As digital content delivery continues to improve and becomes more pervasive, the need for efficient handling of associated metadata increases. Specifically, there are many different types of metadata formats. Each formatting standard typically requires dedicated programming to implement and to convert to another format. Along these lines, new metadata formats generally require a system firmware update to accommodate new formats. Such updates cannot be done in real-time and may take long periods of time to complete. Heretofore, the following metadata-based approaches have been attempted:

U.S. Patent Application No. 20110072456 discloses an Internet Protocol television (IPTV) system which includes an advertising module adapted to: read metadata information associated with an advertising item included within a content item recorded on a set-top box, determine that the advertising item is expired, and send another advertising item to the set-top box to be played on the set-top box in the place of the first advertising item when the content item is played on the set-top box.

U.S. Patent Application No. 20110119726 discloses a method and system which implements supplementary media channels to IPTV channels. An IPTV user may receive a selected IPTV program on an IPTV channel. The IPTV program may be correlated in time with metadata describing the content of the IPTV program.

U.S. Patent Application No. 20100299707 discloses a method and apparatus for receiving metadata regarding an application providing an IPTV service, in which a metadata request message for requesting metadata regarding an application providing at least one IPTV service is generated, the metadata request message is transmitted to a second entity apparatus, and a metadata response message including the metadata regarding the application providing the at least one IPTV service is received from the second entity apparatus, in response to the metadata request message.

U.S. Patent Application No. 20100154015 discloses a metadata search apparatus using speech recognition which includes a metadata processor for processing contents metadata to obtain allomorph of target vocabulary required for speech recognition and search.

U.S. Patent Application No. 20090241154 discloses a method of processing data in an IPTV receiver. The method includes receiving location information necessary to acquire a content corresponding to a content reference identifier (CRID) by using the CRID.

U.S. Patent Application No. 20090198656 discloses an IPTV which collects content information from content providers and a method and system for providing the IPTV with the content information are provided. The IPTV includes a connection unit which enables the IPTV to be connected to the Internet for data transmission or reception over the Internet, a content information collection unit which collects information about content created by IPTV content providers over the Internet, and a content information processing unit which creates standard metadata by processing the collected content information.

U.S. Patent Application No. 20090193483 discloses a method and apparatus for limiting a content usage authority scope of a client by using metadata in an IPTV service. The method performed by a metadata server adds control information to the metadata and transmits the metadata, wherein the content usage authority scope of the client is defined in the control information.

Unfortunately, none of the existing approaches provide for the efficient conversion between formats for metadata associated with digital content.

### SUMMARY

In general, embodiments of the present invention provide an approach for format conversion of metadata associated with digital content. In a typical embodiment, a set of metadata associated with digital content may be received in a computer memory medium. A source format of the set of metadata will then be detected (e.g., by a processor, engine, or combination thereof). Based on the source format, a rule file containing a set of soft conversion rules for the set of metadata will be identified by the processor/engine. Thereafter, a selection of at least one soft conversion rule of the set of soft conversion rules may be received (e.g., from a user, or from an automatic selection made by the processor/engine). The set of metadata may then be mapped and converted to a destination format by the processor/engine using the at least one soft conversion rule.

A first aspect of the present invention provides a computer-implemented method for converting metadata between formats, comprising: receiving a set of metadata associated with digital content in a computer memory medium; detecting a source format of the set of metadata; identifying a rule file containing a set of soft conversion rules for the set of metadata based on the source format; receiving a selection of at least one soft conversion rule of the set of soft conversion rules; and mapping and converting the set of metadata to a destination format using the at least one soft conversion rule.

A second aspect of the present invention provides a system for converting metadata between formats, comprising: a memory medium comprising instructions; a bus coupled to the memory medium; and a processor coupled to the bus that when executing the instructions causes the system to: receive a set of metadata associated with digital content in a computer memory medium; detect a source format of the set of metadata; identify a rule file containing a set of soft conversion rules for the set of metadata based on the source format; receive a selection of at least one soft conversion rule of the set of soft conversion rules; and map and convert the set of metadata to a destination format using the at least one soft conversion rule.

A third aspect of the present invention provides a computer program product for converting metadata between formats, the computer program product comprising a computer readable storage media, and program instructions stored on the computer readable storage media, to: receive a set of metadata associated with digital content in a computer memory medium; detect a source format of the set of metadata; identify a rule file containing a set of soft conversion rules for the set of metadata based on the source format; receive a selection of at least one soft conversion rule of the set of soft conversion rules; and map and convert the set of metadata to a destination format using the at least one soft conversion rule.

A fourth aspect of the present invention provides a method for deploying a system for converting metadata between formats, comprising: providing a computer infrastructure being operable to: receive a set of metadata associated with digital content in a computer memory medium; detect a source format of the set of metadata; identify a rule file containing a set of soft conversion rules for the set of metadata based on the source format; receive a selection of at least one soft conversion rule of the set of soft conversion rules; and map and convert the set of metadata to a destination format using the at least one soft conversion rule.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computing node according to an embodiment of the present invention.

FIG. 2 depicts a system diagram according to the prior art.

FIG. 3 depicts a system diagram according to an embodiment of the present invention.

FIG. 4 depicts a system diagram involving multiple metadata sources according to an embodiment of the present invention.

FIG. 5 depicts a set-top box implementation according to an embodiment of the present invention.

FIG. 6 depicts another set-top box implementation according to an embodiment of the present invention.

FIG. 7 depicts another set-top box implementation according to an embodiment of the present invention.

FIG. 8 depicts a metadata processor as linked to an external engine/processor according to an embodiment of the present invention.

FIG. 9 depicts a metadata processor in conjunction with a platform-independent conversion application according to an embodiment of the present invention.

FIG. 10 depicts a metadata processor with an emergency converter according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Illustrative embodiments will now be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The word “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

In general, embodiments of the present invention provide an approach for format conversion of metadata associated with digital content. In a typical embodiment, a set of metadata associated with digital content may be received in a computer memory medium. A source format of the set of metadata will then be detected (e.g., by a processor, engine, or combination thereof). Based on the detected format, a rule file containing a set of soft conversion rules for the set of metadata will be identified by the processor/engine. Thereafter, a selection of at least one soft conversion rule of the set of soft conversion rules may be received (e.g., from a user, or from an automatic selection made by the processor/engine). The set of metadata may then be mapped and converted to a destination format by the processor/engine using the at least one soft conversion rule.

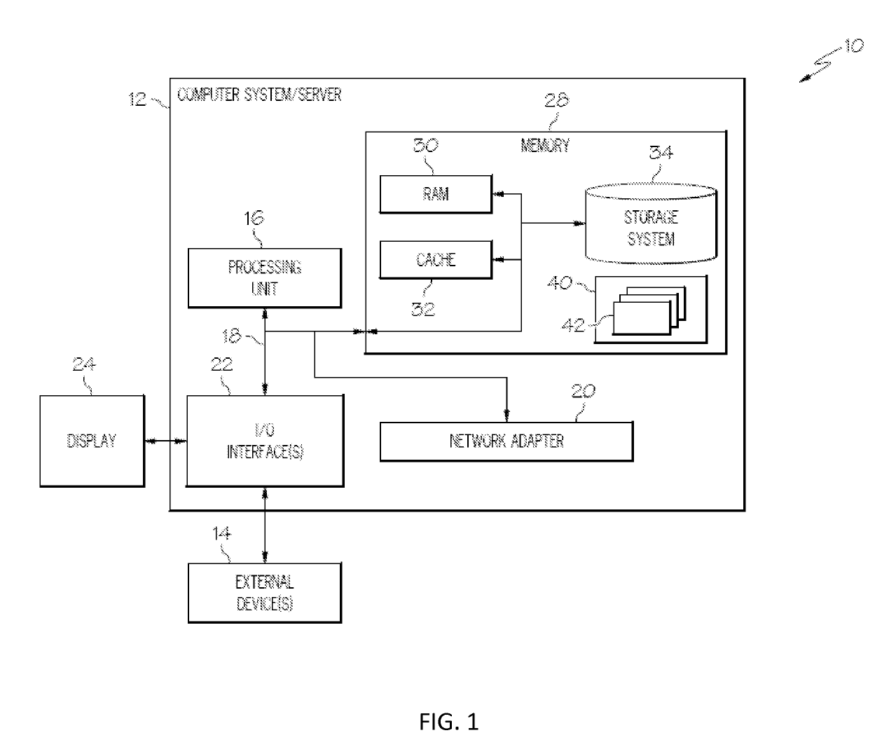

Referring now to FIG. 1, a schematic of an example of a computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth herein. That is computing node 10 may comprise any combinations of hardware (processors) and/or software (e.g., engines, applications, etc.) capable of converting metadata associated with content (e.g., digital).

In computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, mobile devices, global positioning systems (GPS), GPS-enable devices, multiprocessor systems, microprocessor-based systems, set top boxes, programmable consumer electronics, network PCs, minicomputer systems, mainframe computer systems, and distributed computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on, which perform particular tasks or implement particular abstract data types. Computer system/server 12 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

The embodiments of the invention may be implemented as a computer readable signal medium, which may include a propagated data signal with computer readable program code embodied therein (e.g., in baseband or as part of a carrier wave). Such a propagated signal may take any of a variety of forms including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium including, but not limited to, wireless, wireline, optical fiber cable, radio-frequency (RF), etc., or any suitable combination of the foregoing.

Metadata conversion program/utility 40, having a set (at least one) of program modules 42, may be stored in memory 28 by way of example, and not limitation, as well as an operating system, one or more application programs, other program modules, and program data. In general, metadata conversion 40 performs the function of the present invention as described herein. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

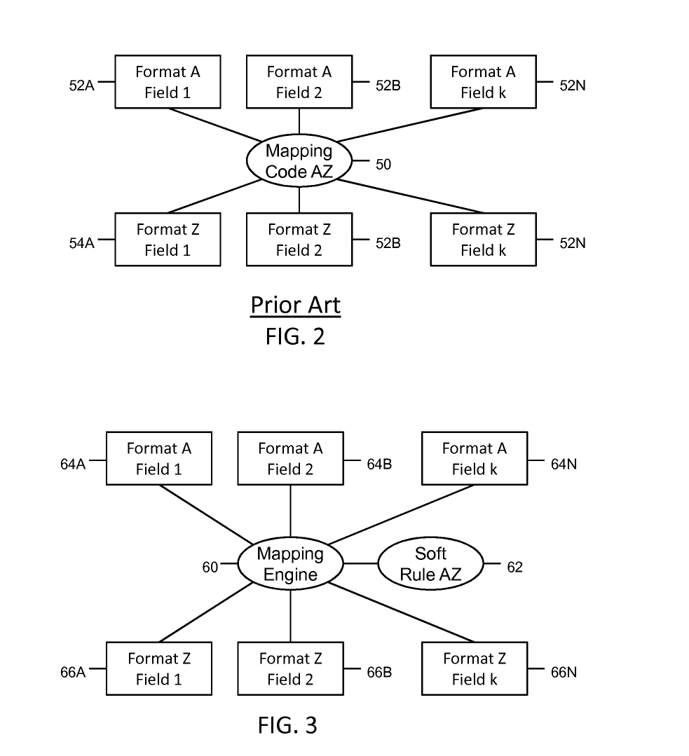

Referring now to FIG. 2, a system diagram according to the prior art is shown. As depicted, mapping code 50 for formats A-Z is provided as firmware to provide mapping between format/fields 52A-N and format/fields 54A-N. Such an approach can require extended update times, cannot be practiced in real-time, and may be highly impractical for user experience.

Referring now to FIG. 3, a system diagram describing the functionality discussed herein according to an embodiment of the present invention is shown. It is understood that the teachings recited herein may be practiced within any type of networked computing environment (e.g., a cloud computing environment). Moreover, it is understood that the teachings recited herein are performed via a “metadata converter”, which may comprise a computing node 10 and/or system 12 such as that shown in FIG. 1, engine(s), processor(s), software application(s), or any combination thereof. In any event, FIG. 3 depicts a mapping engine 60 that leverages a set of soft format conversion rules 62A-Z (e.g., stored in one or more rule files) to map and convert metadata associated with digital content between format/fields 64A-N and format/fields 66A-N.

Along these lines, mapping engine 60 may perform multiple functions. Specifically, among other functions, mapping engine 60 may (among other things): receive a set of metadata associated with digital content in a computer memory medium; detect a source format of the set of metadata; identifying a rule file containing a set of soft conversion rules for the set of metadata based on the source format; receiving a selection of at least one soft conversion rule of the set of soft conversion rules (e.g., based on a set of user preferences such as location, language, age, etc); map and convert the set of metadata to a destination format using the at least one soft conversion rule.

In an embodiment such as that shown in FIG. 3, metadata rules A-Z 62 may be stored/transferred as extensible markup language (XML) or the like, and may be provided either externally or internally, and actively and passively (e.g., by service providers). Multiple scenarios may be implemented to resolve metadata format, and metadata service extensions may be implemented.

### Illustrative Use Cases

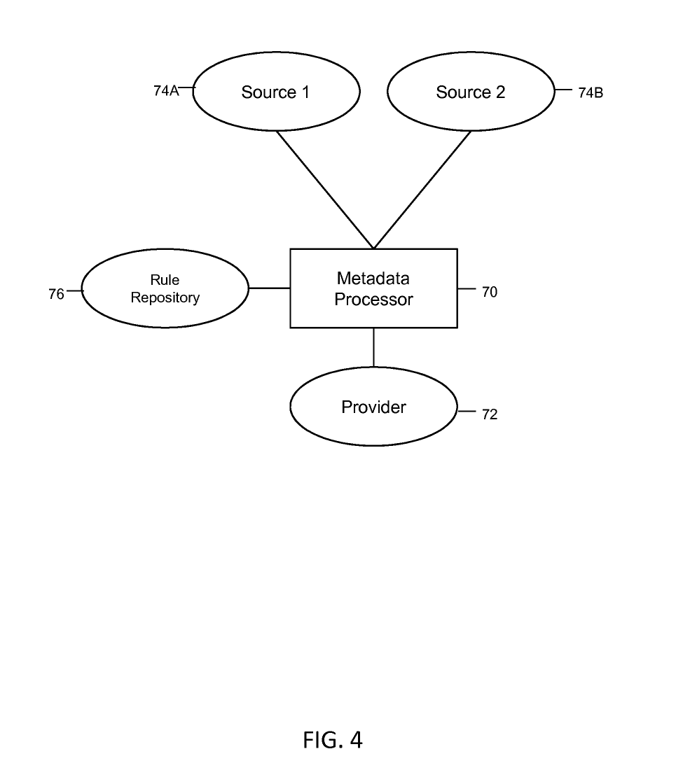

Referring now to FIG. 4, an implementation/use case is depicted where metadata conversion is performed by a provider 72 against multiple content (e.g., video) and metadata sources 74A-B. As depicted, provider leverages metadata processor 70 (which may be implemented via a computing node 10 and/or system 12) to access a rule repository/database (e.g., computer storage device) to identify a particular soft format conversion rule amongst a set of format conversions to convert metadata from sources 74A-B between at least two formats (e.g., between at least one source format and at least one destination format). In general, metadata processor 70 may detect metadata type and load a corresponding conversion rule from repository 76. Among other things, such an implementation provides a way to assume all set-top boxes (STBs) follow a similar metadata format.

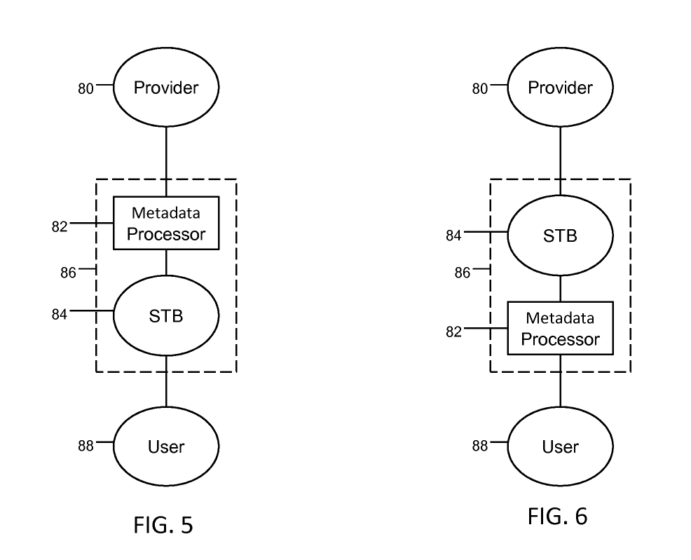

Referring now to FIGS. 5-6, STB implementations are depicted. Specifically, FIG. 5 depicts an implementation whereby a provider 80 communicates directly with metadata processor 82 which communicates directly with STB 84 (shown collectively as a single unit 86). User 88 then receives metadata and/or content directly from STB 84. Conversely, FIG. 6 depicts an implementation whereby a provider 80 communicates directly with STB 84 which communicates directly with metadata processor 82 (shown collectively as a single unit 86). User may then receive metadata and/or content directly from metadata processor 82.

In either scenario, metadata conversion may be performed at the user side for optimal customization. Along these lines, provider 80 may have access to a rule repository or the like. Further, provider 80, STB 84 and/or user 88 may establish metadata conversion requirements. Regardless, selected soft format conversion rules are downloaded along the metadata (selection of a particular rule may be based on user variables such as preference, location, language, age, etc.)

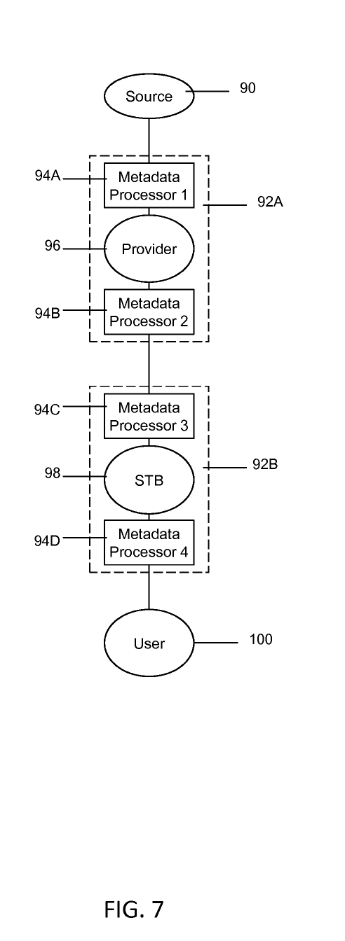

Referring now to FIG. 7, a multi-processor implementation is depicted. As shown, a content/metadata source 90 feeds component unit 92A with a communication flow (e.g., content and/or associated metadata). The component unit 92A comprises metadata processor 94A feeding a provider 96, which in turn feeds metadata processor 94B. The metadata is processed by both metadata processors 94A-B and then fed to component group 92B. As depicted, the communication flow is received by metadata processor 94C and fed to STB 98, which then feeds the communication flow to metadata processor 94D for additional processing and onto user 100.

Thus, as depicted, there may be multiple metadata processors in the distribution architecture. Each processor may be configured to process metadata conversion problems progressively in multiple stages. For example, in FIG. 7, metadata processor 94A may unify different metadata types from multiple sources to simplify provider's metadata repository. Metadata processor 94B may maintain different types of STB standards and may convert metadata corresponding to each STB. Metadata processor 94C may convert metadata based on user's indirect information such as locale, language, etc. Metadata processor 94D may convert and filter metadata based on user's preference such as age, gender, etc.

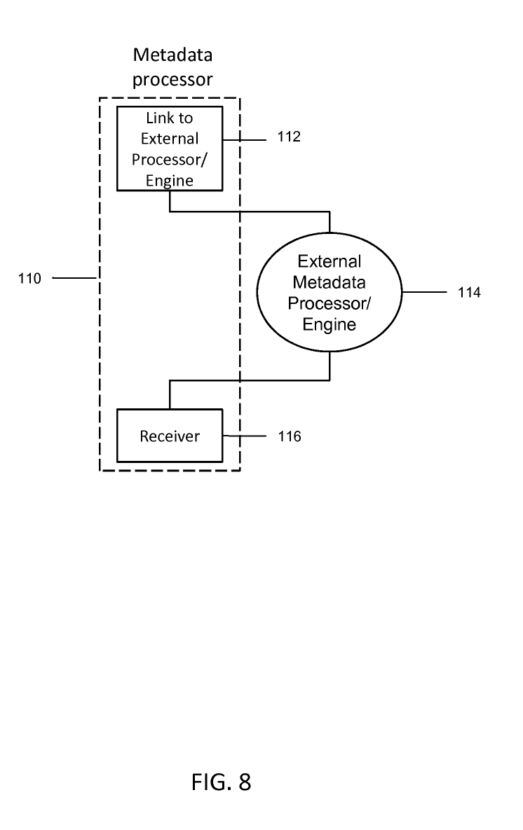

Referring now to FIG. 8, an external metadata processor engine implementation is depicted. As shown, metadata processor 110 comprises a link 112 to an external metadata processor/engine 114, which processes metadata and feeds the processed metadata to receiver 116. Under such an implementation, metadata processor 110 generally invites external metadata processor engine 114. In turn, external metadata processor engine 114 may: provide a pre-converted and stored result from a repository; translate metadata in real-time using a conversion tool such as a language translator; and/or provide a direction to first metadata processor to act on main data.

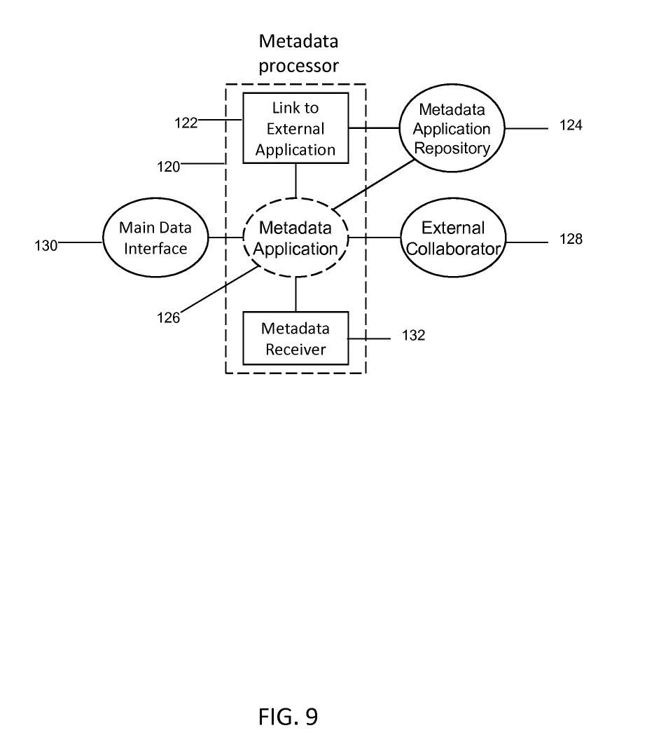

Referring now to FIG. 9, an application-based implementation is depicted. As shown, metadata processor 120 generally comprises a metadata application 126 coupled to a link to an external application 122, a metadata application repository 124, an external collaborator 128, a main data interface 130, and a metadata receiver 132. In general, metadata processor 120 imports a platform independent conversion application, script, or plug-in (e.g., Java® or Javascript®) from a known or user-designated specified metadata application repository 124. Metadata application 126 processes metadata and main data through the application or script.

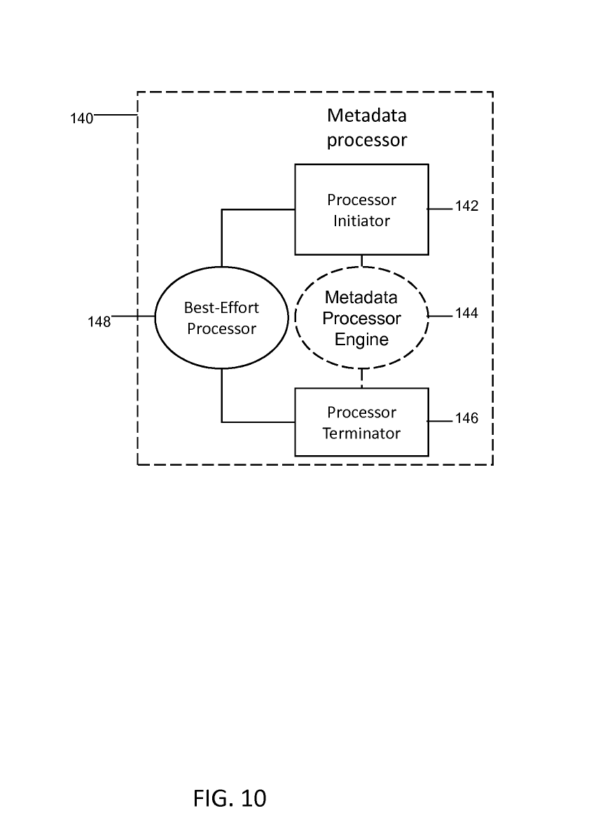

Referring now to FIG. 10, a “best-efforts” implementation is depicted. As shown, metadata processor 140 generally comprises a metadata processor engine 144 coupled to a processor initiator 142 and a processor terminator 146. Processor initiator 142 and processor terminator 146 are themselves coupled to a best-effort processor 148. Under this implementation, the metadata converter may contain an “emergency converter” (e.g., best-effort processor 148) that maps metadata fields with a best-effort analysis and mapping. In general, a best-effort processor may be invoked when a proper conversion rule is not found and downloaded, or external means are not available. Moreover, the best-effort processor 148 may scan metadata to determine best desired fields from the source

While shown and described herein as a metadata format conversion solution, it is understood that the invention further provides various alternative embodiments. For example, in one embodiment, the invention provides a computer-readable/useable medium that includes computer program code to enable a computer infrastructure to provide metadata format conversion as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 28 (FIG. 1) and/or storage system 34 (FIG. 1) (e.g., a fixed disk, a read-only memory, a random access memory, a cache memory, etc.).

In another embodiment, the invention provides a method that performs the process of the invention on a subscription, advertising, and/or fee basis. That is, a service provider, such as a Solution Integrator, could offer to provide metadata format conversion functionality. In this case, the service provider can create, maintain, support, etc., a computer infrastructure, such as computer system 12 (FIG. 1) that performs the processes of the invention for one or more consumers. In return, the service provider can receive payment from the consumer(s) under a subscription and/or fee agreement and/or the service provider can receive payment from the sale of advertising content to one or more third parties.

In still another embodiment, the invention provides a computer-implemented method for metadata format conversion. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

1. A computer-implemented method for converting metadata between formats, comprising:
receiving a set of metadata associated with digital content in a computer memory medium, the set of metadata having been previously generated and associated with the digital content;
detecting a source format of the set of metadata;
identifying a rule file containing a set of soft conversion rules for the set of metadata based on the source format;
receiving a selection of at least one soft conversion rule of the set of soft conversion rules; and
mapping and converting the set of metadata to a destination format using the at least one soft conversion rule.

2. The computer-implemented method of claim 1, the at least one soft conversion rule associating source fields with destination fields.

3. The computer-implemented method of claim 1, the set of metadata being received from at least one metadata source.

4. The computer-implemented method of claim 1, the at least one soft conversion rule corresponding to a type of the set of metadata and the destination format.

5. The computer-implemented method of claim 1, further comprising receiving a set of user preferences, the soft conversion rule being further selected based on the set of user preferences.

6. The computer-implemented method of claim 1, the set of user preferences comprising at least one of the following: location, language, or age.

7. The computer-implemented method of claim 1, the method being enabled via a metadata converter comprising at least one metadata processor and a metadata engine.

8. A system for converting metadata between formats, comprising:
a memory medium comprising instructions;
a bus coupled to the memory medium; and
a processor coupled to the bus that when executing the instructions causes the system to:
receive a set of metadata associated with digital content in a computer memory medium, the set of metadata having been previously generated and associated with the digital content;
detect a source format of the set of metadata;
identify a rule file containing a set of soft conversion rules for the set of metadata based on the source format;
receive a selection of at least one soft conversion rule of the set of soft conversion rules; and
map and convert the set of metadata to a destination format using the at least one soft conversion rule.

9. The system of claim 8, the at least one soft conversion rule associating source fields with destination fields.

10. The system of claim 8, the set of metadata being received from at least one metadata source.

11. The system of claim 8, the at least one soft conversion rule corresponding to a type of the set of metadata and the destination format.

12. The system of claim 8, the memory medium further comprising instructions for causing the system to receive a set of user preferences, the soft conversion rule being further selected based on the set of user preferences.

13. The system of claim 8, the set of user preferences comprising at least one of the following: location, language, or age.

14. The system of claim 8, the system comprising a metadata converter comprising at least one metadata processor and a metadata engine.

15. A computer program product for converting metadata between formats, the computer program product comprising a computer readable storage device, and program instructions stored on the computer readable storage device, to:
receive a set of metadata associated with digital content in a computer memory medium, the set of metadata having been previously generated and associated with the digital content;
detect a source format of the set of metadata;
identify a rule file containing a set of soft conversion rules for the set of metadata based on the source format;
receive a selection of at least one soft conversion rule of the set of soft conversion rules; and
map and convert the set of metadata to a destination format using the at least one soft conversion rule.

16. The computer program product of claim 15, the at least one soft conversion rule associating source fields with destination fields.

17. The computer program product of claim 15, the set of metadata being received from at least one metadata source.

18. The computer program product of claim 15, the at least one soft conversion rule corresponding to a type of the set of metadata and the destination format.

19. The computer program product of claim 15, the computer readable storage device further comprising instructions to receive a set of user preferences, the soft conversion rule being further selected based on the set of user preferences, and the set of user preferences comprising at least one of the following: location, language, or age.

20. A method for deploying a system for converting metadata between formats, comprising:
providing a computer infrastructure being operable to:
receive a set of metadata associated with digital content in a computer memory medium, the set of metadata having been previously generated and associated with the digital content;
detect a source format of the set of metadata;
identify a rule file containing a set of soft conversion rules for the set of metadata based on the source format;
receive a selection of at least one soft conversion rule of the set of soft conversion rules; and
map and convert the set of metadata to a destination format using the at least one soft conversion rule.
